(19) United States
(12) Patent Application Publication
(10) Pub. No.: US 2026/0220631 A1
(43) Pub. Date: Jul. 30, 2026

(54) Bitgood Coin: Raising Money for Noble Social Causes

(71) Applicant: Gideon Samid, Rockville (MD)

(72) Inventor: Gideon Samid, Rockville, MD (US)

(21) Appl. No.: 19/459,999

(22) Filed: Jan. 26, 2026

Related U.S. Application Data
(63) Continuation-in-part of application No. 19/268,130, filed on Jul. 14, 2025.
(60) Provisional application No. 63/749,666, filed on Jan. 26, 2025.
(60) Provisional application No. 63/759,229, filed on Feb. 16, 2025.
(60) Provisional application No. 63/781,339, filed on Mar. 31, 2025.
(60) Provisional application No. 63/870,669, filed on Aug. 26, 2025.

(51) Int. Cl. G06Q 20/38; G06Q 30/0279

(52) U.S. Cl. CPC G06Q 20/389; G06Q 30/0279

(57) ABSTRACT

Minting a digital coin of no intrinsic value, and creating a public attraction, that builds value so that early buyers profit (Ponzi Scheme). By ensuring that the profit is channeled to support a noble social cause, one creates a “Snow White Ponzi Scheme” where all involved (winners and losers) are contributing to the public good, and enjoying a strategic challenge for making a profit on top of the charitable engagement.

This Application is also a continuation in parts of application Ser. No. 18/752,303 filed Jun. 24, 2024. And this Application is also a continuation in parts of application Ser. No. 17/862,285 filed Jul. 11, 2022 which claims benefit of Provisional Application 63/276,662 filed Nov. 8, 2021.

This application is also a continuation in parts of application Ser. No. 17/207,694. This application is also a continuation in part of application Ser. No. 15/582,784 filed May 1, 2017. This application is also a continuation in part of U.S. patent application Ser. No. 14/352,994, filed on Apr. 18, 2014 as national stage application of PCT/US2012/061331, filed on Oct. 22, 2012, which claims the benefit of U.S. Provisional Patent Application Ser. No. 61/627,977, filed Oct. 22, 2011 and U.S. Provisional Patent Application No. 61/688,788, filed May 22, 2012.

This application is also a continuation-in-part of U.S. patent application Ser. No. 15/337,203, filed Oct. 28, 2016, which is a continuation of U.S. patent application Ser. No. 14/737,924, filed Jun. 12, 2015, which is a continuation of U.S. patent application Ser. No. 13/529,399, filed Jun. 21, 2012, which is a continuation of U.S. patent application Ser. No. 12/081,412, filed Apr. 15, 2008, now U.S. Pat. No. 8,229,859, which claims the benefit of U.S. Provisional Patent Application Ser. No. 60/960,672, filed Oct. 9, 2007 and U.S. Provisional Patent Application No. 60/907,869, filed Apr. 19, 2007,

This Application claims the benefit of U.S. Provisional Applications 63/641,398 filed May 1, 2024 and U.S. Provisional Application 63/663,214 filed on 2024 Jun. 24

This Application claims the benefit of U.S. Provisional Application 63/697,576 filed on Sep. 22, 2024, claimed in the continued application.

This Application claims the benefit of Provisional Application 63/749,666 filed Jan. 26, 2025. U.S. Provisional Application 63/759,229 filed Feb. 16, 2025, U.S. Provisional Application 63/781,339 filed on Mar. 31, 2025, US Provisional Application 63/828,891 filed on Jun. 23, 2025, U.S. Provisional Application 63/870,669 filed Aug. 26, 2025
all of which are incorporated by reference in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Digital money practice has shown that currency with no intrinsic value can support a viable durable trade, and build hefty profit for early investors. Such practices known as Ponzi Schemes enrich the few early buyers on account of many late buyers. By a proper design digital coins can be minted to ensure that a noble social cause will be the benefactor of such a “Snow-White Ponzi Scheme”, while the “losers” will win by having contributed to a worthy social cause.

### BRIEF SUMMARY OF THE INVENTION

A Ponzi scheme enriches its originators and its early investors on account of its late joiners. Let these originators be comprised of facilitators, who are social redeemers, so it generates a money flow that benefits a noble social cause. This Snow-White Ponzi Scheme, is facilitated by a digital money enterprise operating a digital money mint, minting digital money coins, Bitgood coins, offered for sale at an arbitrary price, without having any intrinsic value. The enterprise initiates an effective promotion campaign to build value for the minted coins. The money raised by the Enterprise is passed in favor of a designated noble social cause, and is also used to run this Snow-White Ponzi Scheme. Several Snow-White Ponzi schemes run consecutively and in parallel. The Enterprise uses artificial intelligence, AI, to manage the minting rate and the promotion campaign to maximize revenue, and the public is using AI to become Ponzi scheme winners. As more Snow-White Ponzi schemes are executed, they are AI analyzed for improved results, assuring on going public interest, and greater money flow towards noble social causes.

Summary: A Ponzi scheme enriches its originators and its early investors on account of its late joiners. Let these originators be comprised of facilitators, who are social redeemers, so it generates a money flow that benefits a noble social cause. This Snow-White Ponzi Scheme, is facilitated by a digital money enterprise operating a digital money mint, minting digital money coins, Bitgood coins, offered for sale at an arbitrary price, without having any intrinsic value. The enterprise initiates an effective promotion campaign to build value for the minted coins. The money raised by the Enterprise is passed in favor of a designated noble social cause, and is also used to run this Snow-White Ponzi Scheme. Several Snow-White Ponzi schemes run consecutively and in parallel. The Enterprise uses artificial intelligence, AI, to manage the minting rate and the promotion campaign to maximize revenue, and the public is using AI to become Ponzi scheme winners. As more Snow-White Ponzi schemes are executed, they are AI analyzed for improved results, assuring on going public interest, and greater money flow towards noble social causes.

### 1.0 Introduction

Bitcoin has proven that durable crowd expectations for a digital coin of no intrinsic value to rise in price are consistent with human psychology. Despite being backed by no tangible or transactable asset, such digital coin may become attractive and log a track record of price increase for a long time. Even if Bitcoin is a huge Ponzi scheme as its critics argue, very many have experienced a very handsome return on their bitcoin investments.

Now that this durable crowd expectation, DCE, has a proven track record, it can serve in different layouts to benefit society at large. A self-referential coin like bitcoin, call it Bitgood may be minted and offered to the public at arbitrary low price x(0). The offer would be accompanied by a very intense and effective promotional campaign that would generate demand which in turn will increase the price of the Bitgood coin. The price will rise over time. And as it does so, the mint will offer an additional measured amount of new Bitgood coins for sale. Over time (0→t) the mint will collect an amount Z(t). The facilitating Bitgood mint will deduct from the total revenue Z(t) the operating expenses, R(t), including its operating profit, and pass the remainder, Z(t)−R(t) to widely respected, noble social impact organization (SIO). The Bitgood coin may increase its value fast or slow over a long time before it collapses, but any cash passed to the SIO is a net gain that took place because of this “Snow-White Ponzi scheme.”

Success is based on the efficacy of the Bitgood promotional campaign that would drive demand.

The digital money promotion will be hinged on four factors: (i) charity, (ii) profit, (iii) privacy, (iv) transparency. The declared aim of the Bitgood coin campaign is to raise money for a noble social cause. It will tap into the prevailing crowd sentiment to open the wallet to support socially redeemable causes. This Snow-White Ponzi scheme (SW-Ponzi) will awaken these sentiments by the lure of an open ended profit, and the benefit of robust trading privacy. As Bitgood projects register a record of success, they become more attractive to the public, creating an unbound movement with a dramatic charitable impact. All Bitgood transactions may be blockchain documented to achieve total visibility as to allocation of money to the noble cause.

Comparing to normal charitable contribution. Let's assume that the record shows that for a typical Bitgood coin, the supported noble cause receives 75% of the revenue generated by the digital money mint. A charity donor who was prepared to donate $1000 to the cause, will now face the alternative of paying $1333 to achieve the same charitable impact in a worst case scenario for him, but with the prospect to make an open ended amount of money by buying early in the life of the Bitgood coin, and selling later when the price mushrooms. Also this purchase of coin will contribute to the crowd's movement to buy these coins, which in turn will raise its price, and drive in an open ended amount of money, way beyond the $1000 that would be the sum total in the nominal cut-a-check way. As a bonus the giver will be able to enjoy total privacy in trade.

For example, a charity contributor, Alice, buys 100 Bitgood coins at their issue price of 10$/coin. dedicating $1000 for the cause. A week later the price rises to 20$/coin because a stream of early buyers expecting the Snow-White Ponzi effect are also rushing to buy Bitgood. Alice wishes to buy a book on a sensitive subject, and is uneasy about being tracked by the government, so she prefers not to use a named credit card. Alice does not carry coins nor banknotes in her pocket, but she keeps her Bitgood coins in her phone. She buys the book with Bitgood coins at their current rate of $20/coin, paying 2 coins for the book. She thereby buys the book at a 50% discount because Alice bought the book at $10/coin.

Two weeks later the price of the Bitgood coin rises to $40/coin. Alice takes her family to dinner and offers to pay a restaurant bill of $400 with 15 Bitgood coins, reflecting a 50% tip. The restaurant knows they can sell these coins on the spot to cash them against dollars, and it also knows that to reject these coins will appear as being anti-social, not honoring the social cause the coin is promoting, so the restaurant is likely to accept the offer. Alice registers a profit of $250 from this dining out experience. She honored a $400 bill by paying 15 Bitgood coins for which she paid $150.

This particular Bitgood coin gets old, new coins are being minted and attract buyers, so the value declines, as the mint floods the market with new coins and trade fades away. Bob, to his chagrin, bought 25 Bitgood coins at $40/coin (also investing $1000 like Alice), but was unable to sell any. The mint report certifies that 75% of the mint revenue went to the supported cause, so Bob is consoled that $750 of his $1000 expense went to the cause and $250 went to the mechanism that operated the campaign. Bob represents the worst case scenario, which is not bad at all.

Most Bitgood coin buyers find themselves between the highly profitable Alice, and the ‘total loss’ Bob. They all are determined to buy earlier the next Bitgood coin.

Overall there were 10,000 Bitgood coin buyers like Alice and Bob, they bought the Bitgood coin at the average price of $25=(40+10)/2, they bought on average 50=100/2 coins each, generating a mint revenue of:

25*50*10000=12,500,000.00

Of which 75%=$9,375,000.00 are passed to the social cause. Alice is satisfied that she participated in the Bitgood coin sale, helping the cause while securing privacy when it mattered and pocketing $270=$250+$20.

If promotion would attract 100,000 buyers the revenue will be $120.5 million dollars.

The promoters of each successful coin will publicize the stories of the early buyers who profited handsomely from the fast price increase, and thereby create favorable conditions for the next coin.

1.1 Comparison with Normal Charitable Giving

A today's donor to a social cause accepts the fact that a portion, say 20%, of their giving is used by the administrator of the donation program to carry out the donation process. Salaries are being paid, offices rented, travel supported, equipment, supplies, etc. Similarly in this ‘Snow-White Ponzi scheme’ donation the donor knows that an advertised high percentage of the proceeds is dedicated to the social cause while the rest goes for a much cheaper operation (it is cyber land), promotion and realized profits of some donnors who bought low and sold high.

### Bitgood-AI

The Bitgood mint controls the Bitgood dynamics, and is using artificial intelligence, AI, to maximize its giving and its profits. At any given moment the holders of the Bitgood coins are anonymous, which means that the mint may function as a coin trader in secret. The mint can buy coins, it can unmint (remove from the public ledger) any coin it owns. When the mint buys coins it raises their price, when the mint mints more coins and adds them to circulation, it reduces the price. At any moment the mint is free to decide whether to (i) increase the price of the traded coin by buying coins on the market, or (ii) decrease the price of coin by minting more and offering them on the market, or (iii) neither mint more, no buy more—do nothing.

Over the lifetime of the coin (which may be indefinite) the mint can decide over any small interval of time which of the three actions it will take. For actions number (i) and (ii) above, the mint also has to decide the number of coins it buys or sells. This summarizes to a very large degree of freedom, which creates opportunity for optimization. AI is most useful for finding the optimized strategy for coin price impact for the purpose of increasing the bottom-line revenue of the mint, which it then divides between the beneficiary and itself.

At any given moment t, the number of outstanding coins x(t) is comprised of q(t) coins owned by the mint, and p(t)=x(t)−q(t) coins owned by the public. Since the coin holders are anonymous there is no visibility as to how x is divided between the p and the q coins.

The mint can at any point mint added Δx(t) coins so that x(t+Δt)=x(t)+Δx.

When the mint mints a new coin it is first owned by itself. The mint can immediately sell it to itself several times so what the public sees is a new coin that changed hands several times, but it is not clear it the trade happened between bona fide members of the public or it all or part was trade from the mint to the mint. So when the total count of coins in the market (as written on the public ledger) is x(t+δt) it is not clear to the public what is the p portion and what is the q portion. Any transaction from the mint to the mint does not generate money for the mint—but does not cost it money either. The goal of the mint is for the public to purchase the newly minted Bitgood coins, in order for the mint to generate revenue.

Comparison with Lotteries

A lottery may declare support to a noble social cause and thereby lure donors. The lottery ads to the basic donation motivation, an extra incentive: to win the lottery. This Snow-White Ponzi follows the same pattern. Use the basic motivation to support a noble social cause and build on it an opportunity for appealing profit. Some of the donors who buy the Bitgood low and sell it high are winning big. Unlike the lottery which is passive, Bitgood giving is active, participants can strategize, plan ahead, think creatively to do both: support an important social cause and make profit on the side.

### 2.0 Bitgood Promotion

The promoter faces a daunting challenge: to promote a backed by thin air digital coin. It runs the risk of total failure—nobody is buying. Priming is the biggest challenge. This challenge is met through (i) impressing forward the moral imperative to support the universal social cause (a good one must be selected), (ii) pointing out the Snow-White Ponzi effect—early birds make very good money on price increase, (iii) promoting the privacy aspect, as a benefit for the traders, (iv) hailing transparency: donors know exactly where the money is going.

Promotion is achieved by emails, advertisement in normal challenges, and special events payable only with Bitgood coins.

### Special Event Promotion

Events featuring a celebrity can be organized to require admission fee, or purchase fee denominated in Bitgood coins. Such may be music shows, singers, performers. Such may be art galleries where painting and sculptures are shown. The celebrities and artists will promote themselves by announcing that they contribute the proceeds to the cause, and urge their followers to do the same by buying Bitgood coins, which thereby will increase their value and create further impetus to buy more such coins.

The promoter may announce that on a certain future date a popular event will offer a certain number of tickets to be listed per a specified number of Bitgood coins, and these tickets cannot be purchased with any other currency. Anticipating a rush to buy Bitgood coins once the special event is specified many ‘gamblers’ will hurry to buy Bitgood at a low cost in order to sell to the prospective attendees of the event.

### 3.0 Bitgood Coins Procedures and Protocols

The Bitgood digital coin is a digital string comprising:

{Bitgood digital coin}=[mint meta data][coin meta data][coin content]

The mint mints Bitgood coins and posts on a public Bitgood database. Posted coins appear along their ownership ticket. Promotion activity sends the public to that database where members of the public buy and trade Bitgood coins. The trade creates price dynamics. Bitgood coins don't normally disappear, but the mint is free to mint as many as it desires, increasing the coin database. The mint mints coins for free (except for a minimal processing cost), but sells them to members of the public at the momentary going rate. The public trades the coins too. The longer the coin is posted for sale, and maintains a value, the more money flows from the buying public to the mint. Since the Bitgood coin is not redeemable per any accountable obligation, the momentary value of the coin vacillates from zero to any unbound high value. That value may change in an instant, up or down. However as long as the coin is in trade, the mint keeps minting, and there is money flow from buyers to the mint. So the mint at the cost of operation, collects cash from the public.

The amount of cash collected by the mint (Bitgood revenue) depends on the efficacy of the promotion campaign that sends buyers to the Bitgood ledger. The mint obligates itself to pass a given share of the revenue to a recognized organization dedicated to public good, and thereby attracts the public to buy the Bitgood coins. Buyers turning to the ledger find there previously traded coins, plus newly minted coins, owned by the mint, offered for sale (but they are indistinguishable). The mint can suppress the price of the Bitgood coin by minting more coins, or it can elevate the price, but minting less. The mint can even push the price up by buying coins from itself. This is possible because the trade is carried out according to the LeVeL protocol where the owners are anonymous. So the mint will mint a new coin, X, and list it with an ownership ticket identifying an owner through a public designation. Since this is a freshly minted coin, it is clear that the owner is the mint itself. However, the mint can sell coin X to itself (and do so repeatedly) and thereby it is not clear whether the new owner is still the mint or a ‘real new owner’. Any coin sold by the mint (through any of its ownership tickets) increases the mint revenue. Coins traded between members of the public do not increase the mint revenue, but they sustain the price of the coin which allows the mint to keep minting coins and generate more revenue.

### The Bitgood Players

The players: (i) a digital money mint, DMM, “The Mint”, (ii) a digital money promoter, DMP, “The Promoter”, (iii) Members of the Public, “Public”, (iv) A social impact beneficiary, SIB, “The Beneficiary”.

### The Digital Money Mint

The digital money mint is also the enterprise that puts the procedure and the operation together. It is motivated by an underlying goal of exerting a positive impact on society by extracting money from the public for the benefit of a social cause, and is motivated by a normal capitalistic motivation: profit.

The mint commits to share revenue between it and the beneficiary that gives its name, its public reputation, and its moral imperative to the operation. The lion share goes to the designated beneficiary and the rest funds the operation and generates profit which attracts investors to start and run the operation.

The Bitgood operation consists of a growing number of Bitgood coins serving many beneficiaries and many social causes. It is AI optimized so it uses well its accumulated operational experience to constantly improve its operation, raise more money for the social cause and for its own profits.

The mint operational cost are (i) cyber cost, (ii) promotional cost, (iii) overhead. The big cost is promotional cost.

The mint registers itself properly with all the government authorities that have a say, secure any needed licenses, and runs itself as a proper business.

### The Digital Money Promoter

The digital money promoter is a business operation creating outreach operations to the public, building public awareness of the Bitgood activity, and designs and delivers Bitgood promoting events.

The promoter uses any public outreach vehicles to get members of the public to pay and buy Bitgood coins. The attractions are: 1. contributing to a social cause, 2. making a profit, 3. anonymous trading, 4. using Bitgood to buy that which cannot be bought otherwise. The promoter will enlist performing artists to allocate a set number of tickets that are sold only against Bitgood coins. Same for certain shows, museums, etc. The artists will be attracted to enhance their reputation by contributing to the social cause.

### Members of the Public

The universality of the social cause addressed by the Bitgood coin operation will make the Bitgood lure similarly universal. People desiring to make purchases of sensitive items and stay anonymous will find the Bitgood coin a good solution. As Bitgood cases unfold and show how an initial price is rising, it creates a profit attraction in the public who will rush to buy early the next Bitgood coin. The 4th class redirects the people who wish to see a show that sells only with Bitgood coins, or sells cheaper with Bitgood coins, etc.

The wide range public outreach underlies the prospective success of the Bitgood charity operation.

### A Social Impact Beneficiary

The Bitgood operation relies on widely accepted non-controversial social cause contributing organizations. Such are organizations dedicated to cure of a certain disease and to help those who suffer from it. Such are organizations that help handicapped people of various sorts. Organizations dedicated to education, rehabilitation, innovation are all eligible.

The Bitgood operation is to be spanned over many Bitgood coins in parallel, giving the public a range of choices for supported beneficiary. The Bitgood Enterprise will also learn for which causes the method works well and for which not so well.

Not only the social cause should de universally accepted, the same applies to the organizations that support this cause. The public must have confidence in the way the Bitgood money is used by the receiving organization.

### Life Cycle of a Bitgood Coin

A Bitgood coin operation follows the following stages:
1. planning 2. announcing 3. priming 4. gaming 5. closing 6. accounting

The overall duration may be weeks, months, or longer.

### Planning

The Bitgood enterprise, the mint, is setting up a particular Bitgood coin operation by selecting a name for the coin, determining initial value, selecting a beneficiary and signing them up for a deal. Then setting up the cyber apparatus to mint Bitgood coins and construct the public ledger to reflect the minted coins; ensuring any required licenses, insurance, etc.

### Announcing

The enterprise (the mint) will set up a launch date, and prompt the Bitgood promoter to create a spreading public announcement to attract public attention and get as many as possible members of the public to stand by and purchase Bitgood coins right when it is being released for sale. The announcement may reveal the initial price of the Bitgood coin and the initial number of minted coins—although that number is available by counting the coins in the public ledger.

### Priming

Upon launch, the mint will mint x(t=0) coins, and post them in the Bitgood coin public ledger. Immediately q of these x(0) coins will be ‘sold’ by the mint (the current owner) to the mint (reflected like a bona fide buyer). This rush of purchase will bump up the price of the coin. One suitable mechanism is the price adjustment mechanism in the stock market.

A very attractive point for this method is the anonymity of the traders, so an outside observer watching a price rise for the coin will not distinguish between a ‘fake’ situation where all the buyers represent the mint, and a true rise where the buyers are members of the public. Priming is designed to create a buy momentum to bring money into the mint coffers from members of the public. It is noteworthy that priming is not too costly for the mint because in the fake trade the mint sells to itself, losing or gaining no money regardless of the price of the coin. The objective of priming is to attract as many Bitgood buyers as possible paying for a high price coin as possible.

Priming starts as a pre-promotion before launch date, and continues for a set period when the price of the coin combined with the volume of public purchase has reached a target level.

### Gaming

Gaming comes after priming. It amounts to guiding the promoter for a responsive promotion plan, and a dynamics of buying and selling Bitgood coins on the public ledger in order to excite the public to keep buying the coins and at higher prices.

Gaming may take weeks or months. It ends when the mint decides to close this Bitgood coin event normally by flooding the market with newly minted coins.

When the price goes up because members of the public purchase the coin then the mint will cautiously mint and sell new coins in order to generate revenue. If the price decreases the mint may decide to buy Bitgood coins and push the price up, hopefully to generate an up momentum to keep the price soaring. During the gaming period the mint will apply AI inferential engines to decide on the optimal policy of when to sell and when to buy. The responses for each such gaming decision will serve as more input to the AI inference engine to better optimize the gaming strategy.

When a merchant announces that a particular popular merchandise that sell for sau $3000, will be sold for 100 bitgood coins, on an identified future date, then the merchandise set the limit for the value of Bitgood coins to be used for the purchase of the merchandise. That limit is $30/coin. Any lower price will send the public to buy the Bitgood coin in order to buy the merchandise at a discount. So if the current value of the Bitgood coin is $8.00, then this value will rise towards the limit of $30/coin. Other merchants will make similar announcements, creating a hard to predict price dynamics. The motivation for merchants to set up such terms is (i) the same motivation applied to normal discounts, (ii) attract attention to the store, (iii) create a good reputation as supporting the noble social goal.

### Closing

The mint at some point will decide to close a particular Bitgood coin event by flooding the market with newly minted such coins. As the market is being flooded the price drops eventually to near zero, and the mint then decides officially to close this event and submit a final account of all revenues generated and their disposition.

### Accounting

After a Bitgood event is being closed, the mint will account for all the expenses and the revenues and publish most of it publicly to prove that the main impact of this Bitgood operation (event) is to inject the social impact generator organization with more funds to support its noble mission,

### Bitgood Platform

Every single Bitgood coin is introduced to carry a Bitgood event that undergoes the stages described: planning, announcing, priming, gaming, closing, and accounting. Every Bitgood coin has a name and a purpose (identified social impact and social impact recipient). It has a starting day (announcement) and it has a closing date when the price of the coin shrinks to zero.

Several such Bitgood events may run in parallel, be staggered or follow each other. Several Bitgood events can run in different states different localities for different noble causes and for different recipients. All such events run by the same enterprise (same mint) are considered the Bitgood platform.

The Bitgood methodology may be run by a competing enterprise which may also exercise the same or similar methodology. Bitgood platforms may compete with each other.

### Bitgood Coin Encapsulation

The bit screen that carries all the parts of the Bitgood coin is encapsulated with integrity assurance bit strings. They are various digital signatures, bit counts, etc. The encapsulation appears up front of the coin string and on its rear.

### 4.0 Cyber Construction

Cyberwise the Bitgood operation features: (i) the Bitgood coin, (ii) the Bitgood public ledger, (iii) the Bitgood trading platform.

Trading depends on availability of internet connection.

### The Bitgood Coin

The Bitgood digital coin is a digital string comprising:

{Bitgood digital coin}=[mini meta data][coin meta data][coin content]

The Bitgood digital coin is wrapped in a cyber enclosure to ensure its integrity as it is being passed around. We say the Bitgood coin is encapsulated.

The encapsulation includes digital signatures and bit count and other integrity assurance measurements.

### Mint Meta Data

The mint uses an identifying bit string to present itself as the mint. It identifies the Bitgood event to which this Bitgood coin belongs.

### Coin Meta Data

Each coin features a unique public coin id, a private coin id, life-status, record creation time point, the serial number of the first financial bit (fbit) and the serial number of the last financial bit claimed by this coin, notes.

The unique public coin id is listed in the public ledger. The private id is kept private, is known only to the mint and any of the past as well as present owners of the coin.

The life-status of the coin is the indication of whether this listing of the coin in the public ledger represents the latest owner (custodian) of the coin, or whether it represents a past status, namely there is a live record of the coin somewhere in the public ledger.

The record creation time point represents the time stamp of when this record has been created.

A Bitgood coin has a fixed number, f, of financial bits, so a full coin is defined from fbit 1 to fbit f. A coin from fbit x to fbit y where x≤y≤f, contains fbit x to fbit y, namely (y−x+1) bits,

Notes is a section of the coin meta data reserved for notes written either by the mint or by the custodian.

### Coin Content

The content of the coin is an ordered series of f financial bits where a financial bit is a bit string comprising b randomized bits. The contents of the coin then is bf bits. Each of the financial bits is identified by its serial count. The structure of financial bits is designed to assign an identity to each of the f financial bits. By assigning the identity of each of the b bits in the financial bit in a randomized manner, one achieves a desired uncertainty (a desired guessing resistance) towards a stranger guessing the content of the financial bit (known as fbit).

Each fbit carries 1/f of the value of the coin when counted from fbit 1 to fbit f. A Bitgood coin may be identified as a series of sequential fbits, say from bit x to bit y where x≤y≤f. Its value is (y−x+1)/f of the Bitgood coin as a whole.

The fbit division of the bit content of the coin allows for trade in a resolution of 1/f. So if a Bitgood coin is sold for $1000, and f=100, then this coin can be broken to parts at a resolution of $10 each sold separately. A coin must be comprised of consecutive fbits.

The content of the coin does not appear on the Bitgood public ledger, it is known only to the mint and to the past and present owners of the coin. An owner of a coin that carries only fbits from x to y knows only the identity of the fbits from x to y.

### Custody (Ownership) Ticket

Each Bitgood coin is associated with a custody ticket. This ticket lists for all past and present owners (custodians) of the coin their chosen one-way function OWF, and their chosen public keys, PK associated with that OWF. The chosen OWF is indicated by its code in the OWF table which is part of the public ledger.

If the coin is owned by owner (custodian) n, then the custody ticket will feature:

OWFᵢ−PKᵢ
for i=1 to i=n

Each custody ticket will of course identify the unique Bitgood coin id.

### The Bitgood Public Ledger

The public ledger is comprised of:
1. Bitgood coins 2. Bitgood coin custody tickets 3. public ledger management data

The Bitgood coins are listed in a fast access database format, allowing quick search per coin id. Each Bitgood coin is listed with its meta data but without the identity of the fbits.

Each coin listed in the public ledger has a matching ownership ticket which lists the ownership history of the coin through a list of one way function id associated with randomized public keys.

OWFᵢ−PKᵢ
for i=1, 2, . . . t. where t is the number of owners of the coin so far.

The public ledger may be run as a plain database managed by the mint, or as blockchain setup.

### The Bitgood Trading Platform

The Bitgood trading platform consists of public ledgers for all the viable Bitgood coins issued and managed by the mint. It also contains a one-way function database which lists and specifies a growing number of OWFs each denoted with a unique OWF-id. Each coin owner selects (randomly) a OWF from the OWF database, selects a private key to go with the selected OWF, computes the corresponding public key per the selected OWF, and presents the public key and the OWF-id in the ownership ticket per that particular coin. The ownership ticket lists all the selected OWF and their corresponding public key.

### Bitgood Coin Cryptography

Bitgood cryptography is based on the material defined and presented in the continued applications. In summary the minted coins are displayed on the mint public ledger where each coin is associated with its ownership ticket. The ownership ticket is a list of one way functions, (OWF) each combined with a public key (PK). The ticket looks like a series:

OWFᵢ−PKᵢ
for i=1 to i=n for the successive owners of the coin 1, 2, . . . n.

The mint is listing a OWF-collection (database) which lists a growing number of OWF.

Common digital money designs rely on a selected OWF to distinguish between the public who knows the public key to control an account and the single account holder who also knows the matching private key. This is how bitcoin achieves its remarkable achievement of exposing all the circulating coins to the public while hiding the identity of the owners of each of these coins. This reliance on a single shared OWF creates vulnerability. The digital money solution here, called LeVeL, is addressing this vulnerability by offering the money traders a list of OWF to choose from. So while the bitcoin trader selects a pair of private and public keys to participate in the trade, the LeVeL trader selects (randomly) a choice OWF from an ever growing list posted by the mint. The LeVeL digital money solution exploits the fact that while it is rare to find a OWF where the public and private key negate each other in the encryption/decryption process, it is easy to find OWF where it is easy to to compute a public key given a private key but difficult in the reverse. The first owner of a LeVeL coin selects a OWF from the listed OWF (OWF₁), then randomly selects a private key for OWF₁: PR₁, then computes the corresponding public key PK₁, and prepares an ownership ticket for that coin comprising of OWF₁, PK₁. Where OWF₁ on the ownership ticket is a pointer to a particular OWF list in the OWF listing (database).

The listing of this coin, COINⱼ, together with its ownership ticket OTⱼ, are added to the mint published public ledger, LGR, listing coins:
COIN₁, COIN₂, . . . , COINⱼ

In order to convince a payee that the first owner is bona fide, they pass the private key, PR₁ to the payee. The payee verifies (easy) that PR₁ corresponds to PK₁ per OWF₁ and immediately thereafter selects (randomly) any OWF from the OWF listing, OWF₂, selects a corresponding PR₂ (randomly), compute the corresponding PK₂, and modifies the ownership ticket for coin COINⱼ to be:

OTⱼ(2)=[OWF₁−PK₁][OWF₂−PK₂]

Once the OTⱼ is modified the former owner of COINⱼ(OWNERⱼ₁) can not any longer convince another payee that they own COINⱼ because OWNERⱼ₁ cannot pass to the new payee PR₂, which was put there by the first payee, now the 2nd owner of COINⱼ: OWNⱼ₂. Only OWNⱼ₂ is in possession of PR₁ and PR₂ so only they can convince a new payee that COINⱼ is theirs.

OWNⱼ₂ will pay COINⱼ to a new payee by passing to them PR₁, PR₂. The new payee will randomly pick OWF₃ from the OWF listing, select randomly a private key PR₃, compute PK₃, and modify the COINⱼ ownership ticket OTⱼ(3) to list:

OTⱼ(3)=[OWF₁−PK₁][OWF₂−PK₂][OWF₃−PK₃]

Now only OWNERⱼ₃ can claim ownership of COINⱼ because they are the only party that can pass PR₁, PR₂, PR₃ to the next payee.

Similarly, every new owner will add their choice of OWF and corresponding PR, and be the only party who knows all the private keys corresponding to all public keys of the past owners of the same coin, COINⱼ. The OTⱼ for owner i, will feature:

OTⱼ(i)=[OWF₁−PK₁][OWF₂−PK₂] . . . [OWFᵢ−PKᵢ]

Neither the payee, nor the mint have any knowledge of the identity of payor. That is how the mint can mint new coins, sell it to itself, and sell again to itself many times without being exposed for doing so.

The integrity of the public ledger can be assured by any of the common methods used today for similar purpose. It will be the responsibility of the mint to get it right, to be in charge of the dynamic evolution of the public ledger. The MINT will choose between classical database solutions and blockchains variety.

Comparison with Bitcoin
The Enterprise is using the LeVeL-F minting solution which fares well in comparison with Bitcoin, as discussed ahead:

Bitcoin has proven a surprising attribute of human society. An irrational currency which claims to represent absolutely nothing of any transactable value, is traded at sustainable high price for a decade and a half. While critics warn that it is nothing but a longer term Ponzi scheme, the 2009-2025 longevity of the coin is an undeniable fact. This reality suggests an exploitation of this strange societal phenomenon. Bitcoin per se comes with strong anti-social impact: it makes life easier for criminals, terrorists, abusers, and evil doers of all sorts. It beats the tax collector, and it attracts the wealth of its buyers into a state of risk beyond their tolerance. Why then not use this societal readiness to “do bitcoin” over a different coin that will not be contaminated by the anti-social stain that mires bitcoin. Why not mint a coin that will exploit this readiness of the public to invest in an unbacked money, and use this readiness to serve a charitable cause, and support government with ready taxation, thereby ensure government protection and embrace? This question found its answer in LeVeL-F.

Bitcoin is run by a management group responsible for the rules of the coin, but which is not necessarily an owner of the money, and not responsible neither for its ascend nor for its loss of value, even not for any collapse that may occur. The rules are in the open, and bitcoin is traded because its buyers believe that the coin will show durable viability. It is no secret that bitcoin represents nothing more than its naked trade; its value is based on nothing except the unproven belief that the benefits to the trading community will keep it going. All the while it is very clear that since bitcoin represents nothing except the value of its trade, that its value may collapse to zero.

Bitcoin has shown remarkable longevity. Its detractors still belief that its collapse is inevitable, but for about a decade and a half the trade is blossoming, and this fact alone suggests the option to design a better coin that will share this “backed by nothing” status while not sharing the vulnerabilities of bitcoin.

The vulnerabilities of bitcoin are: (i) it is the coin of choice for all sorts of criminals and societal disfavors, (ii) it is not quantum safe, (iii) mining is extremely wasteful with respect to energy, (iv) it is on a clashing course with the prevailing governments and law and order authorities, (v) it has an artificial top number of coins.

LeVeL-F is a digital coin that like bitcoin is backed by the dynamics of its trade, yet it offers a (i) better balance between the demand for freedom and the campaign against the criminal element. (ii) LeVeL-F is quantum safe; (iii) new LeVeL-F coin mining is straight forward and not costly, (iv) LeVeL-F is government friendly—but not government controlled, and (v) LeVeL-F has a flexible control over means to stabilize the value of the coin. (vi) LeVeL-F is fashioned as a vehicle to generate financial contributions to important social causes.

### Overview of the Invention

This invention presents

1. A method to raise public donation for a noble social cause by creating a chance for profit through a strategic challenge to both a donation enterprise, “Enterprise”, and to donors; both the Enterprise and the donors are using artificial intelligence, AI, to maximize profit and maximize donation.

The method is based on a digital coin, “Bitgood Coin” (Bitgood) that is minted by a digital mint, “The Mint,” run by the Enterprise.

The Mint launches a new Bitgood Coin by minting m(0) coins at time t=0, offering them for sale at an arbitrary price p(0).

The Enterprise creates Bitgood attractions by alerting the public to future offers for merchandize, goods, services, entertainment exclusively payable by Bitgood. In anticipation for such offers members of the public buy the Bitgood coin, thereby they increase its price.

As the price of the Bitgood coin rises, the Enterprise mints more, selling them at the new higher price; the Enterprise makes money, and so do early buyers.

The enterprise will increase the price of the Bitgood Coin by simulating members of the public and buy the coins from itself.

At will the Enterprise collects the final amount of money from the Bitgood Coin by offering no more Bitgood attractions, and by flooding the market with newly minted Bitgood Coins which collapse its price.

The enterprise covers its expenses, takes off profit, and passes the rest of the proceeds to a designated organization supporting the noble social cause.

As more and more Bitgood digital coins are offered to the public, there is a growing amount of data describing the price dynamics of a Bitgood coin, and the attractions that move the price; this data serves as input to supervised AI algorithms; the Enterprise uses AI to maximize its revenue, to raise more money for the designated noble social cause, and to make more profit; the donors use AI to better anticipate the coming attractions, to buy Bitgood coins as low as possible and sell them as high as possible; the ever growing challenge keeps the public interest, and increases the amount of money raised for noble social causes.

2. Further to section 1 above the invention describes a situation where the mint puts up a public ledger, LEDGER, listing all the circulating Bitgood Coins; the owner of each Bitgood Coin is recognized by a set of published public keys for which only the owner has a matching set of private keys, with which the OWNER proves to a trading public his ownership of the Bitgood Coin, thereby qualifying as a payor of the coin to any desired payee.

Thereby allowing for a trade where payor and payee may not know their trading partners; and similarly, the Mint will also not know the identity of the payor and the payee of any Bitgood transaction.

3. Further to section 2 above the invention describes a situation where the mint prepares a public library, LIB, of one-way-functions, OWF, each takes in a random number within set limits, as a private key, PR, and very efficiently computes a public key, PK, such that the reverse compute PK→PR is extremely inefficient.

And where the LEDGER lists m minted digital Bitgood Coins. COIN₁, COIN₂, . . . COINₘ, where each coin j while owned by its i-th owner, OWNERⱼᵢ is identified by a unique identifier, COINⱼ, and it points to an arbitrary OWFⱼ₁ in the LIB library, and to an arbitrary public key, PKⱼᵢ, and where OWFⱼᵢ is selected by OWNERⱼᵢ, who randomly selects for it, a private key PRⱼᵢ, and computes a corresponding public key PKⱼᵢ.

And when OWNERⱼᵢ transfers COINⱼ to its OWNER_{j,i+1}, OWNERⱼᵢ proves their identity by passing to OWNER_{j,i+1}, PRⱼ₁, PRⱼ₂, . . . . PRⱼᵢ; and where OWNER_{j,i+1} verifies the identities of PRⱼ₁, PRⱼ₂, . . . PRⱼᵢ by efficiently computing PRⱼₗ→PKⱼₗ for l=1, 2, . . . i.

Upon verifying a match between the computed i public keys and the public keys posted on the public ledger, OWNERᵢ₊₁ accepts the ownership of COINⱼ.

Then OWNERᵢ₊₁ selects OWF_{j,i+1} from the LIB, selects for it a private key PR_{j,i+1}, computes a corresponding public key PK_{j,i+1}, then modifies the public ledger by adding the pair OWF_{j,i+1}, PK_{j,i+1} to the ownership log for coin COINⱼ. And thereby the trading public recognizes OWNER_{j,i+1} as the current owner of COINⱼ.

This procedure applies for all the coins in the ledger. j=1, 2, . . . m, and for each COINⱼ for all the owners OWNERⱼᵢ, for i=1, 2, . . . n(j), where n(j) is the number of owners of COINⱼ.

4. Further to section 1 above the invention describes a situation where the Enterprise mints and sells additional Bitgood Coins when the price of the Bitgood Coin rises, and it simulates buyers of the Bitgood coin when the price drops, in order to maximize its profit and maximize donations to the benefit of the designated noble social cause.

5. Further to section 1 above the invention describes a situation where some merchants agree to offer discounts to customers paying with Bitgood Coins, to increase the attraction of the coin.

6. Further to section 3 above the invention describes a situation where the coin content is expressed through financial bits (fbits); financial bits are fixed size bit strings, b bits per fbit, with randomized bits each. A coin will feature f fbits in sequential order: FBIT₁, FBIT₂ . . . FBIT_{f}.

This fbit expression allows for a Bitgood coin to be split up to a resolution of a single fbit, namely a resolution of 1/f of the pre-split Bitgood coin; the meta data of the coin will identify the count of the first fbit, i in a given split coin, and the count of the last fbit, j in the same split coin, so that the value of the split will be (j−i+1)/f of the pre-split coin.

The bit contents of the fbits will not be posted on the public ledger, but will be passed on from payor to payee.

What is claimed is:

1. A method to raise public donation for a noble social cause by creating a chance for profit through a strategic challenge to both a donation enterprise, “Enterprise”, and to donors; both the Enterprise and the donors are using artificial intelligence, AI, to maximize profit and maximize donation;
the method is based on a digital coin, “Bitgood Coin” (Bitgood) that is minted by a digital mint, “The Mint” run by the Enterprise;
the Mint launches a new Bitgood Coin by minting m(0) coins at time t=0, offering them for sale at an arbitrary price p(0);
the Enterprise creates Bitgood attractions by alerting the public to future offers for merchandize, goods, services, entertainment exclusively payable by Bitgood coins. In anticipation for such offers members of the public buy the Bitgood coin, thereby they increase its price;
as the price of the Bitgood coin rises, the Enterprise mints more, selling them at the new higher price; the Enterprise makes money, and so do early buyers;
the enterprise will increase the price of the Bitgood Coin by simulating members of the public and buying the coins from itself;
at will the Enterprise collects the final amount of money from the Bitgood Coin by offering no more Bitgood attractions, and by flooding the market with newly minted Bitgood Coins which collapse its price;
the enterprise covers its expenses, takes an operational profit, and passes the rest of the proceeds to a designated organization supporting the noble social cause;
as more and more Bitgood digital coins are offered to the public, there is a growing amount of data describing the price dynamics of a Bitgood coin, and the attractions that move the price; this data serves as input to supervised AI algorithms; the Enterprise uses AI to maximize its revenue, to raise more money for the designated noble social cause, and to make more profit; the donors use AI to better anticipate the coming attractions, to buy Bitgood coins as low as possible and sell them as high as possible; the ever growing challenge keeps the public interest, and increases the amount of money raised for noble social causes.

2. The method in claim 1 where the mint puts up a public ledger, LEDGER, listing all the circulating Bitgood Coins; the owner of each Bitgood Coin is recognized by a set of published public keys for which only the owner has a matching set of private keys, with which the OWNER proves to a trading public their ownership of the Bitgood Coin, thereby qualifying as a payor of the coin to any desired payee;
thereby allowing for a trade where payor and payee may not know their trading partners; and similarly the Mint will also not know the identity of the payor and the payee of any Bitgood transaction.

3. The method of claim 2 where the mint prepares a public library, LIB, of one-way-functions, OWF, each takes in a random number within set limits as a private key, PR, and very efficiently computes a public key, PK, such that the reverse compute PK→PR is extremely inefficient;
and where the LEDGER lists m minted digital Bitgood Coins: COIN₁, COIN₂, . . . COINₘ, where each coin j while owned by its i-th owner, OWNERⱼᵢ is identified by a unique identifier, COINⱼ, and it points to an arbitrary OWFⱼᵢ in the LIB library, and to an arbitrary public key, PKⱼᵢ, and where OWFⱼᵢ is selected by OWNERⱼᵢ, who randomly selects for it, a private key PRⱼᵢ, and computes a corresponding public key PKⱼᵢ;
and where OWNERⱼᵢ transfers COINⱼ to its next owner, OWNER_{j,i+1}, OWNERⱼᵢ proves their identity as the current owner of COINⱼ by passing to OWNER_{j,i+1}; PRⱼ₁, PRⱼ₂, . . . PRⱼᵢ;
and where OWNER_{j,i+1} verifies the identities of PRⱼ₁, PRⱼ₂, . . . PRⱼᵢ by efficiently computing PRⱼₗ→PKⱼₗ for l=1, 2, . . . i;
upon verifying a match between the computed i public keys and the i public keys posted on the public ledger, OWNER_{j,i+1} accepts the claimed ownership of COINⱼ, by OWNERⱼᵢ and:
then modifies the public ledger by adding the pair OWF_{j,i+1}, PK_{j,i+1} to the ownership log for coin COINⱼ; thereby the trading public recognizes OWNER_{j,i+1} as the current owner of COINⱼ;
this procedure applies for all the coins in the ledger j=1, 2, . . . m, and for each COINⱼ for all the owners OWNERⱼᵢ, for i=1, 2 . . . n(j), where n(j) is the number of owners of COINⱼ.

4. The method of claim 1 where the Enterprise mints and sells additional Bitgood Coins when the price of the Bitgood Coin rises, and it simulates buyers of the Bitgood coin when the price drops, in order to maximize its profit and maximize donations to the benefit of the designated noble social cause.

5. The method of claim 1 where the merchants agree to offer discounts to customers paying with Bitgood Coins, to increase the attraction of the coin.

6. The method of claim 3 where the coin content is expressed through financial bits (fbits);
financial bits are fixed size bit strings with b randomized bits each, a coin will feature f fbits in sequential order: FBIT₁, FBIT₂ . . . FBIT_{f};
this fbit expression allows for a Bitgood coin to be split up to a resolution of a single fbit, namely a resolution of 1/f of the pre-split Bitgood coin; the meta data of the coin will identify the count of the first fbit, g in a given split coin, and the count of the last fbit, h in the same split coin, so that the value of the split will be (h−g+1)/f of the pre-split coin;
the bit contents of the fbits will not be posted on the public ledger but will be passed on from payor to payee.
